(19) United States
(12) Patent Application Publication
(10) Pub. No.: US 2015/0344765 A1
(43) Pub. Date: Dec. 3, 2015

(54) CLAY-SWELLING INHIBITOR, COMPOSITIONS COMPRISING SAID INHIBITOR AND PROCESSES USING SAID INHIBITOR

(71) Applicant: RHODIA OPERATIONS, Aubervilliers (FR)

(72) Inventors: Thierry BADEL, Lyon (FR); Arnaud CADIX, Saint-Ouen (FR)

(21) Appl. No.: 14/377,359

(22) PCT Filed: Feb. 12, 2013
(86) PCT No.: PCT/EP2013/052774

§ 371 Date: Aug. 7, 2014

Related U.S. Application Data
(60) Provisional application No. 61/637,110, filed on Apr. 23, 2012.

(30) Foreign Application Priority Data
Feb. 14, 2012 (FR) 12 51358

(51) Int. Cl. C09K 8/28; E21B 43/26; E21B 21/16; E21B 21/06; C09K 8/86; C09K 8/52

(52) U.S. Cl. CPC C09K 8/28; C09K 8/86; C09K 8/52; E21B 21/16; E21B 21/062; E21B 43/26; C09K 2208/12

(57) ABSTRACT

The use of an additive as a clay-swelling inhibitor, especially in the field of drilling is described. More specifically, the use of 2-methylpentane-1,5-diamine or an organic or inorganic salt of 2-methylpentane-1,5-diamine as an inhibitor of the swelling of clays in an aqueous medium is described. Also described is a drilling fluid composition or hydraulic fracturing fluid composition including 2-methylpentane-1,5-diamine or an organic or inorganic salt thereof and drilling or hydraulic fracturing processes using the compositions.

The use of a novel additive as a clay-swelling inhibitor, especially in the field of drilling is described herein. Also described is the use of 2-methylpentane-1,5-diamine, or an organic or inorganic salt of 2-methylpentane-1,5-diamine, as an inhibitor of the swelling of clays in an aqueous medium. In addition, a drilling fluid composition or hydraulic fracturing fluid composition is described that comprises 2-methylpentane-1,5-diamine or an organic or inorganic salt thereof and drilling or hydraulic fracturing processes using said compositions.

### BACKGROUND

During well drilling operations, especially when drilling wells intended for recovering underground oil and/or gas fields, use is made of drilling fluids intended to lubricate, clean and cool the drilling tools and the drilling head, and/or to discharge the material broken off during drilling (cleared rocks or cuttings). Drilling fluids are also used for cleaning the well. They also provide the pressure necessary for supporting the well wall before consolidation. The fluids are usually referred to as “drilling muds”. After drilling, the well walls are generally consolidated with a cement material.

During the drilling of wells, in particular during the drilling of wells intended for the production of oil and/or gas, drilling is often carried out through argillaceous rocks, in particular through shales.

The problems posed by argillaceous formations are well known. When these formations are penetrated by drilling using water-based drilling fluids, complex chemical reactions occur within the argillaceous structure by ion exchange and hydration.

These reactions result in a swelling of the clays, a disintegration or a dispersion of the argillaceous particles of the formation passed through by the drilling.

This swelling of the clays poses problems not only in the drilling walls but also in the drilling fluid and in the reservoir rock.

The expression “reservoir rock” is understood to mean the rock formation that contains the oil and/or gas to be extracted.

Due to the hydration of the clays, dispersed particles contaminate the drilling fluid and the reservoir rock, and the disintegration is detrimental to the stability of the well walls. The swelling of these clays also causes operational problems by interfering with the flow of the fluid or the passage of the drilling tool.

Along the well walls, the swelling creates protuberances, which interfere with the movement of the drilling fluid and of the drilling tools. Furthermore, the swelling may result in disintegration, creating bumps along the walls. These bumps and protuberances may create points of mechanical weakness in the well.

In the drilling fluid, the disintegrated argillaceous material is released into the fluid and presents problems of viscosity control of the fluid: the argillaceous materials, especially in the presence of a high concentration of salts (brine), have a tendency to greatly increase the viscosity. This increase in viscosity becomes detrimental and, if it is too high, the drilling tools are damaged. The well may even be rendered unusable.

Furthermore, the cleared argillaceous rocks may have a tendency to aggregate together in the drilling fluid (“bit-balling” phenomenon). Generally, it is referred to as an accretion phenomenon. The accretion may interfere with the movement of the fluids and of the tools. They may furthermore adhere to and aggregate together around the drilling head and thus block it.

The problem presented by the swelling of the clays during drilling in argillaceous formations is closely linked to the phenomena of clay/drilling fluid interactions, especially during clay-water contact.

### PRIOR ART/PROBLEMS

In the field of oil exploitation, the problems mentioned above have especially been solved using non-aqueous drilling fluids, for example a fluid in which the continuous phase is based on a liquid hydrocarbon. But drilling with these types of “oil-base” muds has many drawbacks: prohibitive cost of the fluid, toxicity and especially pollution by the oil of the effluents and debris resulting from the drilling. Current regulations relating to waste disposal henceforth result in treatment costs and techniques such that the oil-base mud is very often impossible to use.

Thus, currently, research and development are essentially focused on aqueous systems in order to find additives that limit the clay-swelling phenomena. These additives are referred to as “clay-swelling inhibitors” and they aim to prevent the penetration of the fluid into the rocks along the walls, into the suspended cleared rocks, and to inhibit swelling and/or disintegration.

Among these additives, there are in particular the following:
mineral salts (KCl, NaCl, CaCl₂, etc.), of which KCl is certainly the salt most commonly used for inhibiting the swelling of clays. Indeed, the potassium ion is a good inhibitor which reduces the electrostatic repulsions between the sheets of clay and therefore the swelling of the clays. Although the Na⁺ ion is not as good an inhibitor as the K⁺ ion, the use of NaCl is also widespread, especially in combination with silicates, polyols or methyl glucosides. Other solutions of mineral salts, such as CaCl₂, or CaBr₂, ZnCl₂, MgCl₂ or MgBr₂ and ZnBr₂ are also widely used as a swelling inhibitor. However, it is increasingly sought to avoid the use of these compounds in the field since inorganic salts, especially chloride salts, have a deleterious effect on the cements used for consolidating the well walls,
aliphatic amines such as hexamethylenediamine as described in patent U.S. Pat. No. 5,771,971,
diamine salts, as described in patent application US 2006/0289164, the counterion of which is a monoacid such as formic acid, a mineral acid, or another acid such as a hydroxy acid (malic or citric acid); and more particularly the salts of hexamethylenediamine with a mineral acid such as hydrochloric acid or a monofunctional organic acid such as formic acid, as described in patent application US 2002/0155956,
polymers intended for consolidating the walls (“wellbore consolidation”). Thus use is currently made of partially hydrolysed polyacrylamides (PHPAs). Patent FR 2185745 describes such a use. These polymers form a polymeric film at the surface of the walls, encapsulate the cleared rocks, and thus inhibit the hydration of the clays. The performances of these polymers are however limited, since they have a tendency to make the fluids too viscous at high concentration. The performances of these polymers are furthermore limited under high-temperature high-pressure (HTHP) drilling conditions due to their limited hydrolytic stability. Moreover, these polymers degrade during their use due to their shear sensitivity. Replacement solutions are therefore needed.

Increasingly restrictive legislations aim to limit the use and/or the risk of disposal of products that are dangerous for humans or for the environment. Replacement solutions that use less harmful and/or more effective additives (which can therefore be used in smaller amounts) are sought.

Therefore, there is still a need to provide clay-swelling inhibitors that perform even better in their application, and that are less dangerous for humans or for the environment.

### BRIEF DESCRIPTION

For this purpose, exemplary embodiments herein propose the use of 2-methylpentane-1,5-diamine (denoted hereinbelow by MPMD) as an inhibitor of the swelling of clays in an aqueous medium.

Exemplary embodiments also relate to the use of an organic or inorganic salt of MPMD as an inhibitor of the swelling of clays in an aqueous medium.

In various embodiments, the MPMD and/or organic or inorganic salts thereof represent at least about 5% by weight relative to the total amount of clay-swelling inhibitor in the aqueous medium, advantageously at least about 10% by weight, and preferably at least about 30% by weight.

Exemplary embodiments also relate to a drilling fluid composition or hydraulic fracturing fluid composition, characterized in that it comprises at least 2-methylpentane-1,5-diamine or organic or inorganic salts thereof, a liquid carrier and optionally additives dissolved or dispersed in the liquid carrier.

Still further embodiments relate to a drilling process in which use is made, in at least one step, of an exemplary drilling fluid composition and a hydraulic fracturing process in which use is made, in at least one step, of a hydraulic fracturing fluid composition according described embodiments.

### DETAILED DESCRIPTION OF THE INVENTION

### Use

Various embodiments use 2-methylpentane-1,5-diamine in free form or in the form of organic or inorganic salt.

According to the present invention “free form” or “free” means that 2-methylpentane-1,5-diamine (MPMD) is not in the form of a salt.

By way of example of inorganic salt, mention can be made of the inorganic salt for which the counterion is a chloride Cl⁻ or a phosphate PO₄²⁻ or a bromide Br.

Regarding the organic salts, they can be a carboxylic acid salt of MPMD, especially a monocarboxylic acid or dicarboxylic acid salt of MPMD, preferably a dicarboxylic acid salt of MPMD.

In one advantageous embodiment, the organic salt of MPMD is a dicarboxylic acid salt of MPMD, the dicarboxylic acid of which is chosen from oxalic acid, malonic acid, succinic acid, glutaric acid, methylmalonic acid, dimethylmalonic acid, ethylmalonic acid, mesaconic acid, methylsuccinic acid, ethylsuccinic acid, maleic acid, fumaric acid, itaconic acid, methylglutaric acid, glutaconic acid, combinations thereof and the like.

Preferably, the organic salt of MPMD is a dicarboxylic acid salt of MPMD, the dicarboxylic acid of which is chosen from oxalic acid, malonic acid, succinic acid, glutaric acid, methylmalonic acid, dimethylmalonic acid, ethylmalonic acid, methylsuccinic acid, ethylsuccinic acid, methylglutaric acid, combinations thereof and the like.

More preferably still, the organic salt of MPMD is a dicarboxylic acid salt of MPMD, the dicarboxylic acid of which is chosen from succinic acid, glutaric acid, methylglutaric acid, combinations thereof and the like.

According to one variant, the salt is a mixed salt of diamine(s) and diacid(s), at least one of the diamines of which is 2-methylpentamethylenediamine. The expression “mixed salt” is understood to mean a salt of one or more different diacids and of one or more diamines, at least one of the diamines of which is 2-methylpentamethylenediamine. For example, it can be a salt between a mixture of diacids such as succinic acid, glutaric acid and adipic acid with 2-methylpentamethylenediamine. It can also be a salt between a mixture of diacids such as methylglutaric acid and ethylsuccinic acid with a diamine such as 2-methylpentamethylenediamine. It can also be a salt between a mixture of diamines such as 2-methylpentamethylenediamine and hexamethylenediamine with a diacid such as methylglutaric acid.

In the case of a mixed salt, the other primary diamines, different from MPMD, may be chosen from the following diamines: diaminoethane, 1,2-diaminopropane, 1,3-diaminopropane, 1,4-diaminobutane, 1,5-diaminopentane, N-(2-aminoethyl)-1,3-propanediamine, 1,2-diaminocyclohexane, 1,4-diaminocyclohexane, 1,6-diaminohexane, bis(3-aminopropyl)amine, 1,7-diaminoheptane, 1,8-diaminooctane, 1,10-diaminodecane, 1,12-diaminododecane, bis(hexamethylene)triamine, combinations thereof and the like.

According to one particularly preferred embodiment, the other primary diamine is hexamethylenediamine (1,6-diaminohexane).

In the mixed salts, the MPMD advantageously represents at least about 50% by weight relative to the mixture of diamines, preferably at least about 60% by weight, advantageously at least about 75% by weight, preferably at least about 85% by weight and more preferably still at least about 90% by weight.

The use, as an inhibitor of the swelling of clays in an aqueous medium, of 2-methylpentane-1,5-diamine or organic or inorganic salts thereof according to described embodiments is advantageously a use in an aqueous medium being a drilling fluid or hydraulic fracturing fluid.

A preferred embodiment uses free 2-methylpentane-1,5-diamine as an inhibitor of the swelling of clays in an aqueous medium.

The MPMD is preferably used pure. “Pure” means that MPMD is at least at a concentration of about 95% by weight, preferably at least at a concentration by weight of about 97% and more preferably still at least about 99% by weight.

It is also possible to use the free MPMD in the presence of other clay-swelling inhibitors, especially other free amines.

Preferably, the MPMD is in the majority in the mixture of clay-swelling inhibitors. In other words, the MPMD represents at least about 50% by weight relative to the total amount of clay-swelling inhibitor, advantageously at least about 75% by weight and more preferably still at least about 90% by weight.

### Composition

Embodiments described herein also target a drilling fluid composition or hydraulic fracturing fluid composition.

Despite the differences that exist between these two ground stimulation techniques, they have a certain number of common points in terms of composition of the fluids used and in particular, the inhibition of the swelling of clays by the fluids used by these two techniques is necessary.

### Drilling Fluids

Drilling fluids are known to those skilled in the art. The exact composition of the fluid can depend on the purpose of the fluid. It can depend in particular on the temperatures and pressures to which the fluid will be subjected, on the nature of the rocks through which the well passes, and on the nature of the drilling equipment.

Generally, the drilling fluid, also called drilling mud, is a liquid and/or gaseous system comprising additives. The main roles of the drilling fluid are:
ensuring that the cuttings rise from the bottom of the well up to the surface,
keeping the cuttings in suspension during a shutdown of circulation for the purpose of preventing the sedimentation of the cuttings in order to restart the drilling without blockage, this being possible owing to the thixotropic nature of the fluid,
cooling and lubricating the tool to avoid premature wear of the moving metal parts,
supporting the well walls due to the hydrostatic pressure exerted by the drilling mud and making it possible to control the inflow of fluids from the rock formations passed through.

The mud should be neither corrosive nor abrasive for the equipment, nor toxic or dangerous for the personnel and it should not present a fire risk.

In the drilling fluids, the rheological and filtration properties are often adjusted by the use of additives. The nature of the additives (also called “electrolytes”) and their concentration in the mud formulations are chosen by taking into account the characteristics of the formation.

Among the additives considered to be important for drilling fluid compositions, are clay-swelling inhibitors.

### Hydraulic Fracturing Fluids:

Hydraulic fracturing is a technique widely used by the oil and gas industry to improve the exploitation of low-permeability reservoirs. The fracturing fluid is pumped to the bottom of the well at high flow rates and high pressures so that the pressure exerted generates fractures in the reservoir rock.

The principle thereof is therefore simple: a pressurized fluid is injected into the rock so as to break it and open fractures through which hydrocarbons will be able to flow to the well.

The implementation of the principle is more complex: it is necessary to add various additives to the injected fluid in order to prevent or substantially inhibit the fractures from closing up as soon as the pressure decreases at the end of the injection operation.

To keep the fractures open after injection, the additive commonly used is a proppant.

Use is made, for example, of ceramic beads, calibrated sand grains which will penetrate into the fractures so that they remain open. In general, a thickener is added to the fracturing fluid so that the proppant particles are entrained into the fractures during the injection and do not form a sediment at the bottom of the well. This sedimentation would be particularly prejudicial in the case of horizontal wells.

Most rock formations contain fine particles of clays and more particularly in the case where the reservoir rocks are of argillaceous nature, the water of the fracturing fluid will swell the clays which will limit the permeability of the network of fractures to the passage of the hydrocarbons. Furthermore, during the fracturing operation, clay particles referred to as “clay fines” can be detached from the walls and then clog, at least partially, the interstices between the particles of proppant (“proppant pack”) and therefore considerably reduce the production of the well. There is therefore, in the case of hydraulic fracturing fluid compositions, also a need to add additives in order to prevent or substantially inhibit the swelling of the clays.

The drilling fluid composition or hydraulic fracturing fluid composition according to exemplary embodiments is characterized in that it comprises at least 2-methylpentane-1,5-diamine or an organic or inorganic salt of 2-methylpentane-1,5-diamine, a liquid carrier and optionally additives dissolved or dispersed in the liquid carrier.

2-Methylpentane-1,5-diamine and the salts thereof according to exemplary embodiments are as defined above in the description and they act as clay-swelling inhibitors.

The content of clay-swelling inhibitor, as a concentration by weight of 2-methylpentane-1,5-diamine active agent, in the drilling or fracturing fluid composition is advantageously from about 0.01% to about 10% by weight, preferably from about 0.1% to about 5%, and more preferably still from about 0.3% to about 3%.

Conventionally, liquid drilling fluids are “water-based” or “oil-based”. Oil-based muds are more expensive than water-base muds, but may be preferred in the case of drilling very deep wells (HP/HT (high pressure/high temperature) drilling conditions). MPMD or salts thereof exemplary embodiments can be used with both types of carriers. However, water-based carriers (water-based mud) are preferred. The liquid carrier is preferably water or an oil-in-water emulsion.

The drilling fluid composition or hydraulic fracturing fluid composition according to exemplary embodiments advantageously comprises additives dissolved or dispersed in the liquid carrier. They may be chosen, in particular, from:
viscosifiers, in particular synthetic polymers;
filtrate reducers, for example chosen from starches or modified starches, carboxymethyl celluloses (CMGs), polyanionic celluloses (PACs), or resins;
clay-swelling inhibitors other than MPMD or salts thereof according to various embodiments, such as for example KCl, glycerol, silicates or various polymers such as partially hydrolysed polyacrylamide (PHPA) and polyalkylene glycols (PAGs);
combinations thereof and the like.

Advantageously, the drilling fluid composition according to exemplary embodiment comprises, in addition, at least one additive dissolved or dispersed in the liquid carrier, chosen from:
i) viscosifiers, for example natural clays (often bentonites), synthetic polymers or biopolymers;
ii) filtrate reducers that are used to consolidate the filter cake in order to limit the invasion of the rock by the drilling fluid such as for example starches and modified starches, carboxymethyl celluloses (CMCs), polyanionic celluloses (PACs), or resins;
iii) other inhibitors of the swelling and dispersion of clays such as for example KCl, glycerol, silicates or various polymers such as partially hydrolysed polyacrylamide (PHPA) and polyalkylene glycols (PAGs);
iv) weighting agents such as barite (barium sulphate BaSO₄) and calcite (calcium carbonate CaCO₃) which are the most widely used for providing the mud with a suitable density. The use of hematite (Fe₂O₃) or of galena (PbS) is also noted,
v) combinations of such additives and the like.

If necessary, it is also possible to use clogging agents such as for example granular agents (nutshells), fibrous agents (sugar cane, wood fibres), lamellar agents (oyster shells, cereals), combinations thereof and the like.

Furthermore, other additives can be incorporated into the composition of the drilling fluid. Thus, mention can be made of free radical transfer agents, biocides, chelating agents, surfactants, antifoams, corrosion inhibitors, combinations thereof and the like.

The hydraulic fracturing fluid composition generally comprises a liquid carrier that is preferably an aqueous fluid, additives dissolved or dispersed in the liquid carrier and a proppant. The proppant is chosen depending on the geological nature of the formation and the type of hydrocarbon to be produced, preferably from sands, ceramics and from polymers, which are optionally treated.

Among the additives which can be incorporated into the hydraulic fracturing fluid composition, are:
i) viscosifiers such as for example synthetic polymers, especially polyacrylamide and polyacrylamide copolymers or biopolymers such as guar gum and modified guar gum or surfactants that form organized phases of giant micelle type;
ii) crosslinking agents such as borates or zirconates that makes it possible to impart viscoelastic rheology to the fluid;
iii) other inhibitors of the swelling and dispersion of clays such as for example KCl, glycerol, silicates or various polymers such as partially hydrolysed polyacrylamide (PHPA) and polyalkylene glycols (PAGs);
iv) friction reducers such as polyacrylamides and polyacrylamide copolymers of very high molar mass;
v) agents that make it possible to clean the fractures just after their formation such as oxidants or enzymes which will degrade the polymers used for the rheological control or the friction reduction during the pumping of the fracturing fluid,
vi) combinations of such additives and the like.

The fracturing fluid composition according to exemplary embodiments can, in addition, comprise agents that make it possible to buffer the pH, bactericides, surfactants or filtrate reducers.

### Processes

Embodiments herein are also directed to a drilling process in which use is made, in at least one step, of a drilling fluid composition as described previously.

The drilling operations generally are comprised of excavating a hole using a bit, attached to hollow pipes screwed end to end. Usually, the mud is initially formulated in a manufacturing tank available on the platform where the various ingredients are mixed with the base fluid of the mud comprising additives in aqueous solution, and is injected into the string of pipes throughout the whole period of drilling advance. This mud subsequently comes back up via the borehole, outside the pipes, and carries along rock components detached during the drilling operation. The mud is subsequently extracted from the drilling hole in order to be stripped of the rocks that it contains, usually by screening or centrifugation, before being reinjected into the hollow drilling pipes.

Embodiments herein are also directed to a hydraulic fracturing process in which use is made, in at least one step, of a hydraulic fracturing fluid composition as described previously.

The hydraulic fracturing is carried out by fracturing the rock via a mechanical stress using a fluid injected under high pressure from a surface drilling, in order to increase the macroporosity and to a lesser extent the microporosity thereof.

Hydraulic fracturing involves the injection of the hydraulic fracturing fluid under high pressure into the reservoir rock in order to propagate fractures therein, which makes it possible to facilitate the production of the hydrocarbons that are found therein.

The fracturing operation is carried out either just after the excavation of the well in order to initiate the production phase thereof, or after a certain operating time when the production tends to decline. Hydraulic fracturing is, for example, carried out as follows:
1. In the zone to be fractured, fractures are initiated by a perforating gun (through a perforated casing).
2. The drilling fluid, previously formulated in surface equipment, is pumped under high pressure.
3. Proppants are added to the fracturing fluid either throughout the whole fracturing operation or, more frequently, when the progression of the fracture is sufficient to introduce this proppant therein.
4. When the progression of the fracture is judged to be satisfactory, the injection is interrupted and the well is kept dormant while the oxidants or enzymes injected with the fluid degrade the polymers (rheological agents or friction reducers).
5. The well is then put back into production.

### Advantages

MPMD has, inter alia, the advantage of remaining liquid over the entire storage temperature range, unlike other aliphatic amines, which facilitates its use.

### Measurements

### Viscosity and Yield Point

The drilling or fracturing fluids have a typical Bingham fluid behaviour characterized by two main parameters, on the one hand the viscosity under flow or plastic viscosity denoted by PV and expressed in centiPoise (cP or m·Pa·s) and on the other hand the yield point denoted by YP (Pa).

These parameters are determined experimentally, using an AR2000 rheometer (TA Instruments, Surrey, Great Britain), equipped with a geometry of grooved plate/plate type having a diameter of 40 mm with a gap of 1 mm. The rheometer is used to carry out a shear rate sweep between 1 and 1000 s⁻¹ at 25° C. The stress (τ) is plotted as a function of the shear rate (\dot{γ}) and the plastic viscosity and yield point values are determined using the Bingham equation below, adapted for fluids at yield:

τ=YP+PV×\dot{γ}

The adjustment of the experimental curves and the determination of the experimental values of YP and PV are carried out using Rheology Advantage Data Analysis V5.7.0 data processing software supplied by TA Instruments.

### Gelling Limit

The clay-swelling inhibitor effect of an additive is determined by evaluating its impact on the swelling, in a given volume of fluid, of variable amounts of standardized clay referred to as API clay (API standing for American Petroleum Institute which standardises the characteristics of test clays in Recommended Practice for Drilling Fluid Materials, API Specifications 13A 16th edition February 2004).

The maximum value of clay that can be introduced, referred to as the gelling limit, is the maximum mass of clay that can be dispersed in 100 ml of fluid containing the swelling inhibitor while retaining a free volume of fluid. Beyond this value, the clay occupies the whole volume of fluid and gelling is observed.

The gelling limit is determined after 4 hours of rest at ambient temperature preceded by a hydration time of the clay in the fluid of 16 h at a temperature of 60° C. During this hydration period, the samples are agitated in a roller oven that makes it possible to avoid the sedimentation of the clay, therefore ensuring a homogeneous hydration throughout the sample. This method of sample homogenization is commonly referred to as hot-rolling in the oil industry.

Other details or advantages of the use of 2-methylpentane-1,5-diamine, or salts thereof, will become more clearly apparent in view of the non-limiting examples below.

### EXAMPLES

### Examples 1 and 1 Bis and Comparative Examples C1 to C4bis

### Clay-Swelling Inhibitor in Free Diamine Form

Various aliphatic amines were evaluated: 2-methylpentane-1,5-diamine, 99.6%, Rhodia; 1-6-hexamethylenediamine, 100%, Rhodia; bis(hexamethylene)triamine, 99%, Sigma-Aldrich; 1,2-cyclohexane diamine, 99%, Sigma-Aldrich. Table 1 summarises the main physical properties thereof:

TABLE 1

| | | | Melting | Boiling |
|---|---|---|---|---|
| Ex | | | point (° C.) | point (° C.) |
| 1 | MPMD | 2-methylpentane diamine | −60 to −50 | 193 |
| C2 | HMD | 1-6-hexamethylenediamine | 39-42 | 205 |
| C4 | BHT | bis(hexamethylene)triamine | 33-36 | 163-165, |
| | | | | 4 mmHg |
| C3 | DCH | 1,2-cyclohexane diamine | 2-15 | 188-192 |
| | pure | | | |
| C4bis | DCH | Mixture (see below) | <20 | 1901 |
| | crude | | | |
| 1bis | DCH | See below | Not | Not |
| | crude + | | measured | measured- |
| | MPMD | | | |

C4bis: DCH crude has the following composition:
1,2-cyclohexane diamine 70-80%
1-6-hexamethylenediamine 10-20%
2-aminocyclopentanemethylamine 1-3%
Impurities (MPMD < 1%)
Example 1bis: A mixture of 90% of DCH crude defined above and 10% of MPMD.

### Clay Swelling Test (Hot Roll Test):

A clay swelling test, generally used by a person skilled in the art, and referred to as a hot roll test was carried out in order to evaluate the performance of the various aliphatic amines cited previously.

The swelling of the clays is determined by a hydration test of 16 h in a roller oven at 60° C. The gelling limit is determined by direct observation of the samples after a rest time of 4 h at ambient temperature.

The various clay-swelling inhibitors are measured out at 1% of active amine in deionised water. Variable masses of API clay are added to 20 ml of fluid containing the inhibitor, in order to determine the gelling limit for each swelling inhibitor.

The rheological properties of the samples thus prepared are also characterized by a rheology measurement as described previously and the plastic viscosity (PV) and yield point (YP) parameters are determined using the Bingham equation. For the purpose of comparing the relative properties of the various swelling inhibitors, the rheological properties are given for an identical clay concentration of 37.5 g per 100 ml of fluid.

The test results and also the rheological properties are reported in Table 2 for Examples 1 and 1bis and the Comparative Examples C1 to C4bis.

TABLE 2

| Examples | C1 | C2 | C3 | C4 | C4bis | 1 | 1bis |
|---|---|---|---|---|---|---|---|
| Additive* | KCl | HMD | DCH pure | BHT | DCH crude | MPMD | DCH crude + |
| | (2%) | | | | (1.33%) | | MPMD (1.33%) |
| Gelling limit | 25 | 37.5 | <22.5 | 30 | Not | 37.5 | Not |
| (g/100 ml) | | | | | measured | | measured |
| PV | 26 | 20 | 37 | 72 | 101 | 18 | 92 |
| (mPa · s)** | (at 25 g/100 ml) | | (at 25 g/100 ml) | | | | |
| YP | 52 | 22 | 70 | 88 | 68 | 15 | 61 |
| (Pa)** | (at 25 g/100 ml) | | (at 25 g/100 ml) | | | | |

*Additive at 1% by weight, unless otherwise mentioned.
**At 37.5 g/100 ml, unless otherwise mentioned.

The higher the gelling limit, and the lower the viscosity and the yield point, the better the performance of the clay-swelling inhibitor. Indeed, concerning gelling limit (maximum value of clay that can be introduced in 100 ml of fluid containing the swelling inhibitor while retaining a free volume of fluid. Beyond this value, the clay occupies the whole volume of fluid and gelling is observed) a higher value means that at a fixed quantity of clay in a fixed volume, the quantity of swelling inhibitor which is necessary to inhibit swelling is lower. As far as viscosity and yield point are concerned, a lower value means that the swelling is less important that is to say there is less disintegration of argillaceous material which are released into the fluid.

Thus, MPMD has a much higher performance level than KCl (used since the 1970s), but also when compared to other aliphatic amines. Surprisingly, MPMD even has a performance level significantly higher than HMD, used since the 2000s. Moreover, when comparing PV and YP of example 1 bis and comparative example C4bis, we remark that addition of MPMD at a significant level allows improvement of the clay-swelling inhibition behaviour of crude DCH (which initially contains MPMD as an impurity (<1% by weight)).

### Example 2

### Clay-Swelling Inhibitor in the Form of a Diamine and Diacid Salt

### Preparation of a Salt of HMD and of Methyl Glutarate

### Comparative Example 5 (C5)

In a 500 ml, four-necked, glass round-bottomed flask, equipped with a mechanical stirrer, a temperature probe, a dropping funnel and a condenser, 40.0 g of HMD (0.344 mol) and 20 g of water are introduced with stirring.

The temperature of the medium is brought to 50° C. using an electric heating mantle. A stoichiometric amount of methylglutaric acid (50.3 g, i.e. 0.344 mol) is then added very gradually and in alternation with water (38 g) to ensure its solubilisation while controlling the exothermicity of the reaction.

At most, the reaction medium is brought to 73° C. The reaction medium is clear.

The reaction medium is then cooled in an ice bath. 100 ml of ethanol are finally added in order to precipitate the salt. The salt is filtered and washed with ethanol, then dried in an oven at 60° C. overnight.

The mass of hexamethylenediamine methylglutarate salt (C5) obtained is 64.8 g (i.e. an experimental yield of 72%). An aqueous solution containing 10% by weight of this salt has a pH of 7.

### Preparation of a Salt of MPMD and of Methyl Glutarate

### Example 2

The 2-methylpentadiamine methylglutarate salt is produced in a similar manner to Comparative Example 5 (C5) above.

### Clay Swelling Test (Hot Roll Test):

The test carried out is identical to that described in Example 1.

The test results and also the rheological properties are reported in Table 3 below for Example 2 and the Comparative Example C5.

TABLE 3

| | | | | Plastic | Yield |
|---|---|---|---|---|---|
| | | | | viscosity | point |
| | | | Gelling | PV (mPa · | Yp (Pa, |
| Exam- | | | limit | s, at 37.5 | at 37.5 |
| ples | Counterion | Diamine* | (g/100 ml) | g/100 ml) | g/100 ml) |
| C5 | Methylglutarate | HMD | 32.5 | 24 | 21 |
| 2 | Methylglutarate | MPMD | 40.0 | 22 | 17 |

The gelling limit is significantly improved and the rheological behaviour is better with the MPMD salt than with the HMD salt. Moreover, plastic viscosity and yield point are also slightly improved with the MPMD salt. Thus, when globally comparing the two salts in terms of clay-swelling inhibition, MPMD salt is considered as significantly better than HMD salt.

1. A method of inhibiting swelling of clay in an aqueous medium, comprising introducing to the aqueous medium an amount of 2-methylpentane-1,5-diamine or of an organic or inorganic salt of 2-methylpentane-1,5-diamine effective to inhibit swelling of the clay in the aqueous medium.

2. The method according to claim 1, wherein the 2-methylpentane-1,5-diamine and/or organic or inorganic salts thereof represent at least about 10% by weight relative to the total amount of clay-swelling inhibitor in the aqueous medium.

3. The method according to claim 1, wherein the organic salt of the 2-methylpentane-1,5-diamine is a carboxylic acid salt of 2-methylpentane-1,5-diamine.

4. The method according to claim 3, wherein the organic salt of 2-methylpentane-1,5-diamine is a monocarboxylic acid or dicarboxylic acid salt of 2-methylpentane-1,5-diamine.

5. The method according to claim 1, wherein the organic salt of 2-methylpentane-1,5-diamine is a salt of 2-methylpentane-1,5-diamine and an organic dicarboxylic acid selected from the group consisting of oxalic acid, malonic acid, succinic acid, glutaric acid, methylmalonic acid, dimethylmalonic acid, ethylmalonic acid, mesaconic acid, methylsuccinic acid, ethylsuccinic acid, maleic acid, fumaric acid, itaconic acid, methylglutaric acid, glutaconic acid, and combinations thereof.

6. The method according to claim 5, wherein the organic salt of 2-methylpentane-1,5-diamine is a salt of 2-methylpentane-1,5-diamine and a dicarboxylic acid selected from the group consisting of oxalic acid, malonic acid, succinic acid, glutaric acid, methylmalonic acid, dimethylmalonic acid, ethylmalonic acid, methylsuccinic acid, ethylsuccinic acid, methylglutaric acid, and combinations thereof.

7. The method according to claim 6, wherein the organic salt of 2-methylpentane-1,5-diamine is a salt of 2-methylpentane-1,5-diamine and a dicarboxylic acid selected from the group consisting of succinic acid, glutaric acid, methylglutaric acid, and combinations thereof.

8. The method according to claim 1, wherein the salt is a mixed salt of one or more different diamines and one or more different dicarboxylic acids, and wherein at least one of the diamines is 2-methylpentamethylenediamine.

9. The method according to claim 8, wherein the diamines other than 2-methylpentane-1,5-diamine are selected from the group consisting of diaminoethane, 1,2-diaminopropane, 1,3-diaminopropane, 1,4-diaminobutane, 1,5-diaminopentane, N-(2-aminoethyl)-1,3-propanediamine, 1,2-diaminocyclohexane, 1,4-diaminocyclohexane, 1,6-diaminohexane, bis(3-aminopropyl)amine, 1,7-diaminoheptane, 1,8-diaminooctane, 1,10-diaminodecane, 1,12-diaminododecane, bis(hexamethylene)triamine, and combinations thereof.

10. The method according to claim 9, wherein the diamine other than 2-methylpentane-1,5-diamine is 1,6-diaminohexane.

11. The method according to claim 8, wherein the salt is a mixed salt of a mixture of diamines and a dicarboxylic acid or dicarboxylic acids and the 2 methylpentane-1,5-diamine in the mixed salt represents at least about 50% by weight relative to the mixture of diamines.

12. The method according to claim 1, wherein the aqueous medium is a drilling fluid or a hydraulic fracturing fluid.

13. A drilling fluid composition or hydraulic fracturing fluid composition, comprising 2-methylpentane-1,5-diamine or an organic or inorganic salt of 2-methylpentane-1,5-diamine, a liquid carrier and optionally, one or more additives dissolved or dispersed in the liquid carrier.

14. The composition according to claim 13, wherein the liquid carrier is water or an oil-in-water emulsion.

15. The composition according to claim 13, wherein the composition comprises at least one additive, dissolved or dispersed in the liquid carrier, selected from the group consisting of a viscosifier, a filtrate reducer, a clay-swelling inhibitor other than 2-methylpentane-1,5-diamine or an organic or inorganic salt of 2-methylpentane-1,5-diamine, and combinations thereof.

16. A drilling process, comprising injecting a drilling fluid composition according to claim 13 into a drill pipe.

17. A hydraulic fracturing process, comprising injecting a hydraulic fracturing fluid composition according to claim 13 into a rock.
